(19) United States
(12) Patent Application Publication
(10) Pub. No.: US 2025/0121715 A1
(43) Pub. Date: Apr. 17, 2025

(54) ELECTRICAL SYSTEM FOR A MOTOR VEHICLE

(71) Applicant: VITESCO TECHNOLOGIES GMBH, Regensburg (DE)

(72) Inventors: Roland D'AUTHIER, BIOT (FR); Cédric LAURENT, BIOT (FR); Lionel DOLMAIRE, Toulouse (FR)

(21) Appl. No.: 18/682,008

(22) PCT Filed: Sep. 8, 2022
(86) PCT No.: PCT/EP2022/074966

§ 371 Date: Feb. 7, 2024

(30) Foreign Application Priority Data
Oct. 4, 2021 (FR) FR2110477

(51) Int. Cl. B60L 53/22; B60L 1/00; B60L 50/60; H02M 1/42; H02M 3/00; H02M 3/335

(52) U.S. Cl. CPC B60L 53/22; B60L 1/00; H02M 1/4208; H02M 3/01; H02M 3/33576; B60L 50/60; B60L 2210/10

(57) ABSTRACT

This relates to an electric system for a motor vehicle, the vehicle including at least one power supply battery, the electric system including an electric charger intended to be connected, on the one hand, to the battery and, on the other hand, to an electric network outside the vehicle supplying an AC voltage or to electric equipment, and a microcontroller, the charger being able to charge the battery from an external electric network or to allow the battery to power the equipment, the charger including a power factor corrector circuit and a converter.

### TECHNICAL FIELD

The invention relates to the field of electric or hybrid vehicles and more specifically to electric systems for electric or hybrid vehicles comprising an on-board charger and a microcontroller, and to the method implemented by said electric system.

### PRIOR ART

As is known, an electric or hybrid vehicle comprises a battery able to supply electric power in order to power electric equipment installed in the vehicle or outside the vehicle and the electric machine of the vehicle.

The vehicle also comprises an on-board charger, more commonly referred to as OBC (On-Board Charger), connected to the battery. When the on-board charger is also connected to electric equipment, it allows the DC voltage supplied by the battery to be converted into an AC voltage in order to power the electric equipment to which it is connected. In addition, the on-board charger also can be connected to an electric power supply network, and in this case it allows the AC voltage supplied by the network to be converted into DC voltage in order to recharge the battery.

As is known, an on-board charger comprises a power factor corrector circuit (PFC), a DC-DC current converter, a link capacitor connected in parallel between the power factor corrector circuit and the current converter, and a microcontroller able to control the power factor corrector circuit.

For example, when the battery is charging, the power factor corrector is the element of the on-board charger able to convert an AC voltage, supplied by an electric network outside the vehicle, into a DC voltage set between 400 and 800 V. The link capacitor allows the residual oscillations in the DC voltage supplied by the power factor corrector circuit to be eliminated. The DC-DC converter is then able to convert the DC voltage smoothed by the capacitor into another DC voltage value, ranging between approximately 200 and 400 V, that is able to charge the battery.

Notably, the microcontroller is able to control the power factor corrector circuit. Thus, for example, the microcontroller controls the corrector circuit in order to set the value of the DC voltage supplied by the corrector circuit and set between 400 and 800 V as a function of the state of charge of the battery.

Thus, in this case, the link capacitor must be adapted to withstand high voltages ranging from 400 to 800 V. However, the more the capacitor is adapted to withstand high voltages, the more expensive and bulky it becomes.

Similarly, the various electronic components of the power factor corrector circuit and of the DC-DC converter also must be adapted to withstand voltages of up to 800 V, so as not to be damaged.

In addition, when the voltage supplied by the converter or the corrector circuit is high, notably above 600 V, heating occurs in the on-board charger, which can cause a loss of efficiency of the order of 1 to 3%. A cooling device must be added in order to dissipate the heat that is emitted and thus prevent damage to the electronic components of the on-board charger.

A solution is therefore needed in order to at least partly overcome these disadvantages.

### DISCLOSURE OF THE INVENTION

To this end, the invention relates to an electric system for a motor vehicle, the vehicle comprising a power supply battery, the electric system comprising an electric charger intended to be connected, on the one hand, to said battery and, on the other hand, to an electric network outside the vehicle supplying an AC voltage or to electric equipment, and a microcontroller, the charger being able to charge the battery from an external electric network or to allow the battery to power said equipment, the charger comprising:
a. a power factor corrector circuit able to convert an AC voltage into a DC voltage;
b. a DC-DC voltage converter connected between the power factor corrector circuit and the battery and able to convert a DC voltage into another DC voltage, said DC-DC voltage converter comprising a first H-bridge, and a second H-bridge, each H-bridge comprising four switches, a first switch being connected between a high point and a midpoint, a second switch being connected between the midpoint and a low point, a third switch being connected between the high point and a second midpoint and a fourth switch being connected between the second midpoint and the low point, the voltage converter also comprising a transformer electrically connecting the first H-bridge and the second H-bridge, each H-bridge being able to operate in:
   i. a first operating mode, in which the first switch and the fourth switch are open and closed simultaneously, the second switch and the third switch are open and closed simultaneously in contrast to the first switch and the fourth switch;
   ii. a second operating mode, in which the fourth switch is always closed, the third switch is always open, and the first switch and the second switch are alternately open and closed;
      the microcontroller is configured for:
1. commanding the opening and closing of each switch of the first bridge and of the second bridge of the DC-DC voltage converter by transmitting a command signal to each switch that is characterized by a frequency, with the high state of the command signal for commanding the closure of a switch and the low state of the command signal for commanding the opening of a switch;
2. when the microcontroller receives a request to transition from the first operating mode to the second operating mode for the first bridge, respectively the second bridge:
   i. transmitting a close command to the fourth switch and an open command to the third switch of the first bridge, respectively of the second bridge;
   ii. setting the frequency of the command signal transmitted to the first switch and to the second switch of the first bridge, respectively of the second bridge, to a first predefined maximum frequency value for a predetermined duration;
   iii. deactivating, when the predetermined duration has elapsed, the second active operating mode and activating the first operating mode of the first bridge, respectively of the second bridge;
3. when the microcontroller receives a request to transition from the second operating mode to the first operating mode for the first bridge, respectively the second bridge:
   i. setting the frequency of the command signal transmitted to each switch of the first bridge, respectively of the second bridge, to a second predefined maximum frequency value for a predetermined duration;
   ii. when the predetermined duration has elapsed, deactivating the first active operating mode and activating the second operating mode of the first bridge, respectively of the second bridge.

Thus, advantageously, the power variation function is provided by the converter controlled by the microcontroller. In addition, increasing the frequency of each command signal before changing the operating mode allows the DC-DC voltage converter to reach the desired frequency more quickly when the operating mode will be subsequently changed. Therefore, this allows the DC-DC voltage converter to be more responsive to rapid variations in power demand and avoids significant variations in the voltage of the link capacitor. In this way, this protects the electronic components of the on-board charger from problems of overvoltage and overheating in said on-board charger.

Preferably, the on-board charger comprises a link capacitor connected between the power factor corrector circuit and the DC-DC voltage converter able to attenuate the residual oscillations of the voltage supplied between the power factor corrector circuit and the DC-DC voltage converter.

Advantageously, the converter comprises:
a. a transformer comprising a primary winding and a secondary winding, each winding comprising a first terminal and a second terminal;
b. a first resonant circuit comprising a resonant capacitor and a coil connected in series, the resonant capacitor of the first resonant circuit being electrically connected to the first midpoint of the first bridge, and the coil of the first resonant circuit being electrically connected to the first terminal of the primary winding of the transformer;
c. a second resonant circuit comprising a resonant capacitor and a coil connected in series, the resonant capacitor of the second resonant circuit being electrically connected to the first midpoint of the second bridge, and the coil of the second resonant circuit being electrically connected to the first terminal of the secondary winding of the transformer.

The electric system thus allows the voltage at the terminals of the capacitor of the first and second resonant circuits to be returned to its average voltage value immediately before changing the operating mode. Thus, when restarting following a change of operating mode, this avoids having to apply high voltage at the terminals of the first, second, third or fourth switches, which could damage said switches.

Advantageously, a first frequency range defines the set of frequencies of the command signal for which the first bridge or the second bridge operates in the first operating mode and a second range of frequencies defines the set of frequencies of the command signal for which the first bridge or the second bridge operates in the second operating mode, with the first maximum frequency value being equal to the maximum frequency of the frequency range of the second operating mode and the second maximum frequency value being equal to the maximum frequency of the frequency range of the first operating mode.

Even more preferably, the converter comprises an additional coil, connected in parallel with the primary winding of the transformer. Notably, the additional coil can be inside or outside the transformer. When the additional coil is outside the transformer, the converter corresponds to a resonant DC-DC voltage converter of the CLLLC type.

Advantageously, each switch designates a MOSFET or bipolar transistor.

The invention also relates to a motor vehicle comprising at least one battery and at least one electric system as described above.

The invention also relates to a method for activating an operating mode of a converter of an electronic system for a motor vehicle as described above, said method being implemented by the microcontroller, when the microcontroller receives a request to transition from the first operating mode to the second operating mode for the first bridge, respectively the second bridge, the method comprising the steps of:
i. transmitting a close command to the fourth switch and an open command to the third switch of the first bridge, respectively of the second bridge;
ii) setting the frequency of the command signal transmitted to the first switch and to the second switch of the first bridge, respectively of the second bridge, to a first predetermined maximum frequency value for a predetermined duration;
iii) deactivating, when the predetermined duration has elapsed, the second operating mode and activating the first operating mode of the first bridge, respectively of the second bridge.

Preferably, when the microcontroller receives a request to transition from the first operating mode to the second operating mode for the first bridge, respectively the second bridge, the method comprises the steps of:
a. setting the frequency of the command signal transmitted to each switch of the first bridge, respectively of the second bridge, to a second predefined maximum frequency value for a predetermined duration;
b. deactivating, when the predetermined duration has elapsed, the first operating mode and activating the second operating mode of the first bridge, respectively of the second bridge.

The invention also relates to a computer program product, characterized in that it comprises a set of program code instructions, which, when they are executed by one or more processors, configure the one or more processors to implement a method as described above.

### DESCRIPTION OF THE DRAWINGS

Further features and advantages of the invention will become more clearly apparent upon reading the following description. This description is purely illustrative and should be read with reference to the appended drawings, in which:

FIG. 1 schematically illustrates the electric system according to the invention;

FIG. 2 shows the electronic circuit of the charger converter of the electric system according to FIG. 1;

FIG. 3 schematically illustrates the method according to the invention.

### DESCRIPTION OF THE EMBODIMENTS

### Vehicle

An embodiment of the vehicle according to the invention will now be described. The vehicle is notably an electric or hybrid vehicle and notably comprises an electric machine able to convert electric energy into mechanical energy in order to set into rotation the wheels of the vehicle. The electric machine therefore corresponds to the electric propulsion motor of the vehicle.

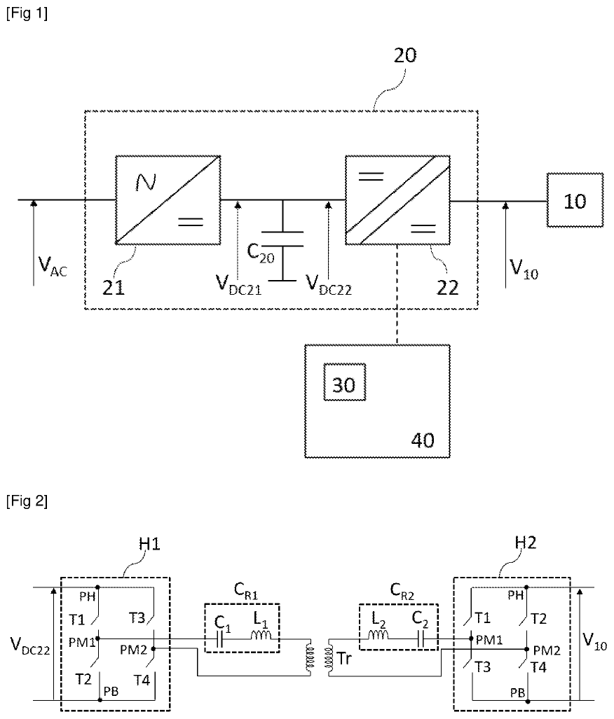

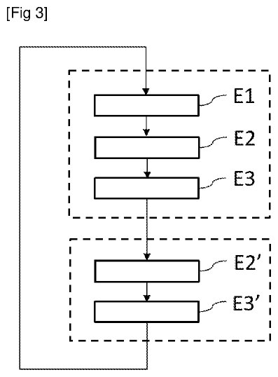

With reference to FIG. 1, the vehicle also comprises a power supply battery 10 and an electric system comprising an on-board charger 20 and a microcontroller 40.

### Battery 10

Notably, the power supply battery 10 is able to operate in a discharge mode, in which the battery 10 supplies energy to equipment installed in the vehicle or to other equipment outside the vehicles that could be connected to the battery 10 or to the electric machine.

The battery 10 is also able to operate in a charge mode, in which the battery 10 is able to charge from electric energy supplied by an electric network electrically connected to the battery 10.

For example, the voltage of the battery 10 can be set between 400 V or 800 V.

### Charger 20

The charger 20, better known as the OBC (On-Board Charger), is connected, on the one hand, to the battery 10 and, on the other hand, to at least one item of equipment that is installed in the vehicle or outside the vehicle, or to an electric network able to supply an AC voltage.

The charger 20 is referred to as “bidirectional”. Indeed, when the charger 20 is connected to an electric network and the battery 10 is operating in the charge state, the charger 20 is notably able to convert the AC voltage supplied by the electric network into a DC voltage able to charge the battery 10. Moreover, when an item of electric equipment is connected to the charger 20, the battery 10 operates in the discharge state, the charger 20 is able to convert the DC voltage supplied by the battery 10 into an AC voltage able to power the equipment.

More specifically, the charger 20 comprises a power factor corrector circuit 21, a DC-DC voltage converter 22 and a link capacitor C20. The converter 22 is electrically connected to the corrector circuit 21 via a wired link. In addition, the link capacitor C20 is connected on a branch on the wired link connecting the corrector circuit 21 and the converter 22.

In addition, the converter 22 is adapted to be electrically connected to the battery 10 and the power factor corrector circuit 21 is adapted to be electrically connected to an item of equipment of the vehicle or outside the vehicle or to an electric network.

### Corrector Circuit 21

Still with reference to FIG. 1, the power factor corrector circuit 21 is able to convert an AC voltage VAC into a DC voltage VDC21, and vice versa.

### Converter 22

The DC-DC voltage converter 22 is able to convert a DC voltage VDC22 into another DC voltage V10. The conversion ratio between the DC voltage VDC22 and the DC voltage V10 is variable and is notably set by a value within a range set between 0.4 and 1.3.

### Link Capacitor C20

The link capacitor C20 is able to attenuate the residual oscillations of the DC voltage supplied between the power factor corrector circuit 21 and the DC-DC voltage converter 22.

For example, when the battery 10 is operating in the charge mode, the corrector circuit 21 is connected to an electric network 60. Thus, the corrector circuit 21 converts the AC voltage supplied by the electric network into a DC voltage VDC21 substantially set to 400 V. However, the DC voltage VDC21 has an AC portion, in other words the DC voltage VDC21 has residual oscillations, for example, of plus or minus 30 V. The link capacitor C20 allows the residual oscillations of the DC voltage VDC21 to be eliminated. Finally, the converter 22 converts the DC voltage VDC22 without residual oscillations into a DC voltage V10 suitable for recharging the battery 10, for example, a DC voltage between 220 V and 465 V.

Conversely, when the battery 10 is operating in the discharge mode, then this means that the corrector circuit 21 is connected to an item of electronic equipment 50 to be powered. The converter 22 converts the DC voltage V10 supplied by the battery 10 into another DC voltage VDC22, for example, approximately equal to 400 V. The DC voltage VDC22 supplied by the converter 22 has an alternating portion, in other words, the DC voltage VDC22 has residual oscillations, for example, of plus or minus 30 V. The link capacitor C20 allows the residual oscillations of the DC voltage VDC22 to be eliminated. Finally, the corrector circuit 21 converts the DC voltage VDC21 without residual oscillations substantially set to 400 V into an AC voltage able to supply electric power to the electric equipment connected to said corrector circuit 21.

Thus, the value of the maximum DC voltage applied at the terminals of the link capacitor C20 is substantially equal to or close to 400 V. The nominal voltage of the link capacitor C20 is selected as a function of this DC voltage constraint. Notably, the link capacitor C20 has a nominal voltage that is at least greater than the maximum DC voltage applied thereto. Preferably, the link capacitor C20 has a nominal voltage that is slightly higher than the maximum DC voltage applied thereto. Thus, since the nominal voltage of the link capacitor C20 and the value of the maximum DC voltage that is applied thereto are close, the capacitor C20 is not under-utilized and is able to fully discharge or charge.

The detailed electronic structure of the converter 22 will now be described. The converter 22 corresponds to a CLLC or CLLLC resonant DC-DC voltage converter.

With reference to FIG. 2, the converter 22 corresponds to a CLLC resonant DC-DC voltage converter and comprises a transformer Tr, a first H-bridge, designated H1 in FIG. 2, a second H-bridge, designated H2, in FIG. 2, a first resonant circuit CR1 and a second resonant circuit CR2.

The transformer Tr comprises a primary winding and a secondary winding, each winding comprising a first terminal and a second terminal.

Each bridge H1, H2 comprises four switches, a first switch T1 being connected between a high point PH and a midpoint PM1, a second switch T2 being connected between the midpoint PM1 and a low point PB, a third switch T3 being connected between the high point PH and a second midpoint PM2 and a fourth switch T4 being connected between the second midpoint PM2 and the low point PB.

The switches T1, T2, T3, T4 can designate any type of switch, and notably, MOSFET or bipolar transistors.

The first resonant circuit CR1 comprises a resonant capacitor C1 and a coil L1 connected in series. By analogy, the second resonant circuit CR2 comprises a resonant capacitor C2 and a coil L2 connected in series.

The resonant capacitor C1 of the first resonant circuit CR1 is electrically connected to the first midpoint PM1 of the first bridge H1, and the coil L1 of the first resonant circuit CR1 is electrically connected to the first terminal of the primary winding of the transformer Tr.

The second terminal of the primary winding of the transformer Tr is electrically connected to the second midpoint PM2 of the first bridge H1.

The resonant capacitor C2 of the second resonant circuit CR2 is electrically connected to the first midpoint PM1 of the second bridge H2, and the coil L2 of the second resonant circuit CR2 is electrically connected to the first terminal of the secondary winding of the transformer Tr.

The second terminal of the secondary winding of the transformer Tr is electrically connected to the second midpoint PM2 of the second bridge H2.

For example, the transformer Tr is able to supply an output voltage between the terminals of the secondary winding that is equal to the voltage applied between the terminals of the first winding. This ratio of 1 between the output voltage and the voltage applied across the terminals of the first winding can be modified.

The converter 22 also comprises an additional coil (not shown in the figures) in parallel with the primary winding of the transformer Tr. The additional coil can be inside or outside the transformer Tr. When the additional coil is outside the transformer Tr, the converter 22 corresponds to a resonant DC-DC voltage converter of the CLLLC type.

### H-Bridge Operating Mode

The first bridge H1, respectively the second bridge H2, is also able to operate in a first operating mode, in which the first switch T1 and the fourth switch T4 are open and closed simultaneously. Furthermore, in the first operating mode, the second switch T2 and the third switch T3 are opened and closed simultaneously, unlike the first switch T1 and the fourth switch T4. The first operating mode is known to a person skilled in the art as “Full-Bridge”.

The first bridge H1, respectively the second bridge H2, is able to operate in a second operating mode, in which the fourth switch T4 is always closed, the third switch T3 is always open, and the first switch T1 and the second switch T2 are alternately open. The second operating mode is known to a person skilled in the art as “Half-Bridge”.

Notably, the second operating mode allows the voltage gain of the converter 22 to be reduced compared with the voltage gain of the converter 22 when it is operating in the first operating mode.

### Microcontroller 40

The microcontroller 40 is connected to the charger 20.

The microcontroller 40 comprises a controller 30 and more specifically a PID (Proportional-Integral-Derivative) controller. In the present case, the controller 30 is able to obtain the value of the DC voltage V10 measured between the converter 22 and the battery 10. Similarly, the controller 30 is able to obtain the value of the voltage VAC measured between the corrector circuit 21 and the electric equipment 50 (or the electric network 60) connected to said corrector circuit 21.

The controller 30 is also able to receive the voltage setpoint to be applied between the converter 22 and the battery 10 and/or the voltage setpoint to be applied between the corrector circuit 21 and the electric equipment 50 connected to said corrector circuit 21.

The controller 30 is able to determine whether each measured value corresponds to the received voltage setpoint to be applied.

In addition, when a measured value does not correspond to the corresponding setpoint value, the controller 30 is configured to issue at least one instruction to the microcontroller 40 in order to modify the conversion ratio of the converter 22, so that each measured value corresponds to the corresponding setpoint. The instruction issued by the controller 30 notably includes a control frequency value.

The controller 30 is also able to measure the current at the terminals of the battery 10.

The microcontroller 40 is able to periodically receive the value of the current at the terminals of the battery 10 measured by the controller 30.

The microcontroller 40 is able to control the converter 22. More specifically, the microcontroller 40 is able to control the opening and closing of each switch T1, T2, T3, T4 of the first bridge H1 and of the second bridge H2. Thus, the microcontroller 40 is able to control the activation and deactivation of the first operating mode and the activation and deactivation of the second operating mode of the first bridge H1 and of the second bridge H2.

Notably, when the battery 10 is operating in the charge mode, the microcontroller 30 controls the first bridge H1. Conversely, when the battery 10 is operating in the discharge mode, the microcontroller 40 controls the second bridge H2.

Even more specifically, the microcontroller 40 is able to control the opening and closing of each switch T1, T2, T3, T4 of the first bridge H1 and of the second bridge H2, notably using the frequency modulation method. To this end, the microcontroller 40 transmits a command signal to each switch T1, T2, T3, T4. Each command signal is defined by a periodic square-wave signal, the duty cycle of which is notably 50%. In other words, the command signal relating to a switch T1, T2, T3, T4 alternates between a “high” state for commanding the closure of said switch, and a “low” state for commanding the opening of said switch. The opposite also can be the case, the high state can command the opening of said switch and the low state can command the closure of said switch.

Each command signal is therefore characterized by a frequency. More specifically, a first range of frequencies defines the set of frequencies of the command signal (and therefore the set of opening and closing frequencies of the switches T1, T2, T3, T4) for which the first bridge H1 or the second bridge H2 operates in the first operating mode. Similarly, a second frequency range defines the set of frequencies of the command signal (and therefore the set of opening and closing frequencies of the switches T1, T2, T3, T4) for which the first bridge H1 or the second bridge H2 operates in the second operating mode. Thus, when the microcontroller 40 activates the first operating mode, respectively the second operating mode, of the first bridge H1 or of the second bridge H2, the microcontroller 40 defines the frequency of each command signal transmitted to the switches T1, T2, T3, T4 of said bridge by selecting a value from among the first, respectively the second, frequency range.

The microcontroller 40 is able to set and/or modify the frequency of each command signal. For example, the microcontroller 40 is configured to apply the command frequency included in the instruction issued by the controller 30 to each command signal, in order to modify the conversion ratio of the converter 22.

Furthermore, the microcontroller 40 can also control the constant closing, respectively opening, of a switch T1, T2, T3, T4 by transmitting a closing, respectively opening, signal to said switch T1, T2, T3, T4.

The microcontroller 40 comprises a processor able to implement a set of instructions that allows these functions to be performed.

### Method:

An embodiment of the method for activating an operating mode of the first or second bridge H1, H2, implemented by the microcontroller 40, will now be described.

Firstly, the microcontroller 40 determines the need to transition from the second operating mode to the first operating mode for the first bridge H1, respectively the second bridge H2, or vice versa.

By way of an example, in the event that the battery 10 is operating in the charge mode and there is a need to transition from the second operating mode to the first operating mode for the first bridge H1, the method comprises a step E1 of transmitting a close command to the fourth switch T4 and an open command to the third switch T3 of the first bridge H1.

The method also comprises a step E2 of setting the frequency of the command signal transmitted to the first switch T1 and to the second switch T2 of the first bridge H1 to a first predefined maximum frequency value for a predetermined duration, notably defined between 100 μs and 150 μs. In addition, the command signal transmitted to the first switch T1 and that transmitted to the second switch T2 are set so that the first switch T1 and the second switch T2 open and close alternately.

Notably, the first maximum frequency value can be equal to the maximum frequency of the second frequency range of the second operating mode or can be a predefined value.

Then, when the predetermined duration has elapsed, the method comprises a step E3 of deactivating the second operating mode and of activating the first operating mode of the first bridge H1. In other words, the microcontroller 40 activates the new operating mode only after changing the frequency to the predefined maximum frequency value as described for a predetermined duration.

As a further example, when the microcontroller 40 determines the need to transition from the first operating mode to the second operating mode for the first bridge H1, the method comprises a step E2′ of setting the frequency of the command signal transmitted to each switch T1, T2, T3, T4 of the first bridge H1 to a second predefined maximum frequency value for the predetermined duration. In addition, the command signals are set so that the first switch T1 and the fourth switch T4 are open and closed simultaneously, the second switch T2 and the third switch T3 are open and closed simultaneously in contrast to the first switch T1 and the fourth switch T4.

The second maximum frequency value is notably equal to the maximum frequency of the first frequency range of the first operating mode or to a predefined value.

Then, when the predetermined duration has elapsed, the method comprises a step E3′ of deactivating the first operating mode and of activating the second operating mode of the first bridge H1. As for the deactivation step E3, the microcontroller 40 activates the new operating mode only after having changed the frequency to the predefined maximum frequency value as described for a predetermined duration.

The method also can be implemented in a similar way when the battery 10 is operating in the discharge mode. However, in this case, the command signal will not be transmitted to the switches T1, T2, T3, T4 of the second bridge H1, but to the switches of the first bridge H2.

1. An electric system for a motor vehicle, the vehicle comprising at least one power supply battery, the electric system comprising an electric charger intended to be connected, both to said battery and also to an electric network outside the vehicle supplying an AC voltage or to electric equipment, and a microcontroller, the charger being able to charge the battery from an external electric network or to allow the battery to power said equipment, the charger comprising:
a) a power factor corrector circuit able to convert an AC voltage into a DC voltage;
b) a DC-DC voltage converter connected between the power factor corrector circuit and the battery and able to convert a DC voltage into another DC voltage, said DC-DC voltage converter comprising a first H-bridge, and a second H-bridge, each H-bridge comprising four switches, a first switch being connected between a high point and a midpoint, a second switch being connected between the midpoint and a low point, a third switch being connected between the high point and a second midpoint and a fourth switch being connected between the second midpoint and the low point, the voltage converter also comprising a transformer electrically connecting the first H-bridge and the second H-bridge, each H-bridge being able to operate in:
i. a first operating mode, in which the first switch and the fourth switch are open and closed simultaneously, the second switch and the third switch are open and closed simultaneously in contrast to the first switch and the fourth switch;
ii. a second operating mode, in which the fourth switch is always closed, the third switch is always open, and the first switch and the second switch are alternately open and closed;
the microcontroller is configured for:
1. commanding the opening and closing of each switch of the first bridge and of the second bridge of the DC-DC voltage converter by transmitting a command signal to each switch that is characterized by a frequency, with the high state of the command signal for commanding the closure of a switch and the low state of the command signal for commanding the opening of a switch;
2. when the microcontroller receives a request to transition from the first operating mode to the second operating mode for the first bridge, respectively the second bridge:
i. transmitting a command to close the fourth switch and a command to open the third switch of the first bridge, respectively of the second bridge;
ii. setting the frequency of the command signal transmitted to the first switch and to the second switch of the first bridge, respectively of the second bridge, to a first predefined maximum frequency value for a predetermined duration;
iii. when the predetermined duration has elapsed, deactivating the second active operating mode and activating the first operating mode of the first bridge, respectively of the second bridge;
3. when the microcontroller receives a request to transition from the second operating mode to the first operating mode for the first bridge, respectively the second bridge:
i. setting the frequency of the command signal transmitted to each switch of the first bridge, respectively of the second bridge, to a second predefined maximum frequency value for a predetermined duration;
ii. when the predetermined duration has elapsed, deactivating the first active operating mode and activating the second operating mode of the first bridge, respectively of the second bridge.

2. An electric system as claimed in claim 1, wherein the on-board charger comprises a link capacitor connected in parallel between the power factor corrector circuit and the DC-DC voltage converter able to attenuate the residual oscillations of the voltage supplied between the power factor corrector circuit and the DC-DC voltage converter.

3. The electric system as claimed in claim 1, wherein the converter comprises:
a) a transformer comprising a primary winding and a secondary winding, each winding comprising a first terminal and a second terminal;
b) a first resonant circuit comprising a resonant capacitor and a coil connected in series, the resonant capacitor of the first resonant circuit being electrically connected to the first midpoint of the first bridge, and the coil of the first resonant circuit being electrically connected to the first terminal of the primary winding of the transformer;
c) a second resonant circuit comprising a resonant capacitor and a coil connected in series, the resonant capacitor of the second resonant circuit being electrically connected to the first midpoint of the second bridge, and the coil of the second resonant circuit being electrically connected to the first terminal of the secondary winding of the transformer.

4. The electric system as claimed in claim 1, wherein a first frequency range defines the set of frequencies of the command signal for which the first bridge or the second bridge operates in the first operating mode and a second range of frequencies defines the set of frequencies of the command signal for which the first bridge or the second bridge operates in the second operating mode, with the first maximum frequency value being equal to the maximum frequency of the frequency range of the second operating mode and the second maximum frequency value being equal to the maximum frequency of the frequency range of the first operating mode.

5. The electric system as claimed in claim 4, wherein the converter comprises an additional coil, connected in parallel with the primary winding of the transformer.

6. The electric system as claimed in claim 1, wherein each switch designates a MOSFET or bipolar transistor.

7. A motor vehicle comprising at least one battery and at least one electric system as claimed in claim 1.

8. A method for activating an operating mode of a converter of an electronic system for a motor vehicle as claimed in claim 7, said method being implemented by the microcontroller, when the microcontroller receives a request to transition from the first operating mode to the second operating mode for the first bridge, respectively the second bridge, the method comprising the steps of:
i) transmitting a close command to the fourth switch and an open command to the third switch of the first bridge, respectively of the second bridge;
ii) setting the frequency of the command signal transmitted to the first switch and to the second switch of the first bridge, respectively of the second bridge, to a first predetermined maximum frequency value for a predetermined duration;
iii) when the predetermined duration has elapsed, deactivating the second operating mode and activating the first operating mode of the first bridge, respectively of the second bridge.

9. The activation method as claimed in claim 8, when the microcontroller receives a request to transition from the first operating mode to the second operating mode for the first bridge, respectively the second bridge, the method comprising the steps of:
i. setting the frequency of the command signal transmitted to each switch of the first bridge, respectively of the second bridge, to a second predetermined maximum frequency value for a predetermined duration;
ii. when the predetermined duration has elapsed, deactivating the first operating mode and activating the second operating mode of the first bridge, respectively of the second bridge.

10. A non-transitory, computer-readable medium on which is stored a set of program code instructions, which, when executed by one or more processors, configure the one or more processors to implement the method as claimed in claim 8.
